(19) United States
(12) Patent Application Publication
(10) Pub. No.: US 2016/0186795 A1
(43) Pub. Date: Jun. 30, 2016

(54) THREADED SCREW WITH SHANK SLOT

(71) Applicant: Mid-State Bolt and Nut Co., Inc., Columbus, OH (US)

(72) Inventor: Joseph Schneider, Columbus, OH (US)

(21) Appl. No.: 14/970,416

(22) Filed: Dec. 15, 2015

Related U.S. Application Data
(60) Provisional application No. 62/091,765, filed on Dec. 15, 2014.

(51) Int. Cl. F16B 25/00; F16B 23/00; F16B 25/10

(52) U.S. Cl. CPC F16B 25/0078; F16B 25/0084; F16B 25/10; F16B 23/003

(57) ABSTRACT

The present invention is an improved screw fastener design that exhibits greater holding power and a reduction in installation time over previously known designs.

### CROSS-REFERENCE TO RELATED APPLICATION

This application claims priority to provisional application 62/091,765 filed on Dec. 15, 2014 and is incorporated by reference in its entirety as if fully recited herein.

### TECHNICAL FIELD

The present invention relates to fasteners, particularly to screw fasteners used to join two or more materials together.

### BACKGROUND OF THE ART

Various types of fasteners, particularly screws, are commonly used for connecting different materials together. It is desirable that the fasteners used maintain a tight grip between the materials being fastened. One example is screws used to install floorboards in vehicles and other automotive applications. In these types of applications the floorboards are subject to a high degree of vibration. Floorboard screws are therefore highly susceptible to losing their grip and disengaging from their installed position, which can jeopardize the stability of the floorboards and the overall safety of the vehicle. This is but one example of why it is desirable to have a screw that can maintain a strong grip on the materials it connects.

It is also desirable to have a screw that is hardened and can withstand the pressure and forces it is subjected to during use without losing its grip on the materials or otherwise deforming.

It is also desirable to have a screw fastener that can be installed in less time and with less force, to make the manufacturing process easier and more efficient.

It is therefore an object of the present invention to provide a novel screw fastener which effects a firmer grip between the two or more materials being fastened, is durable, and can be installed in less time.

### BRIEF DESCRIPTION OF THE DRAWINGS

A better understanding of the exemplary embodiments will be obtained from a reading of the following detailed description and the accompanying drawings, wherein identical reference characters refer to identical parts and in which:

FIG. 1 is a side elevational view of an embodiment of a screw fastener.

FIG. 2 is an end view of the screw fastener of FIG. 1, taken from the tapping point end.

FIG. 3 is an end view of the screw fastener of FIG. 1, taken from the head end.

FIG. 4 is a cross-sectional view of the screw fastener of FIG. 1 being used to hold two materials together.

FIG. 5 is a drawing illustrating the dimensions of an example embodiment of the invention with triple leads.

FIG. 6 is a drawing illustrating the dimensions of an example embodiment of the invention with four leads.

FIG. 7 is a drawing illustrating a preferred installation of an embodiment of the invention.

FIG. 8 is a top view image of a test fixture for comparison of embodiments of the invention against known screw designs.

FIG. 9 is an end view image of a test fixture for comparison of embodiments of the invention against known screw designs.

FIG. 10 is an additional end view image of a test fixture for comparison of embodiments of the invention against known screw designs.

### DESCRIPTION OF THE PREFERRED EMBODIMENTS

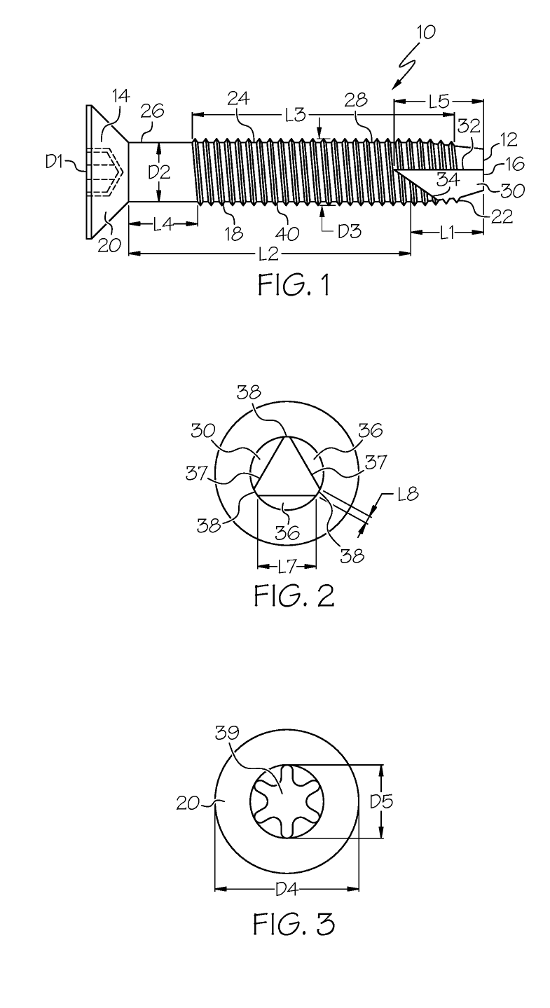

FIG. 1 is an improved screw 10 that may be used to fasten two or more materials together. The screw 10 has a first end 12 and a second end 14, with a blunt tapping point 16 provided at the first end 12. A shank 18 runs between the first end 12 and second end 14. At the second end 14 is a head 20. At the first end 12 the shank 18 has a tapered portion 22 along a predetermined axial length L1 that ends at the tapping point 16 that has a tapping point width D1. In a preferred embodiment of the invention, the tapered portion may have an point taper length of about 0.283 inches. The remainder of the shank 18 between the tapered portion 22 and the head 20 has a fairly consistent minor diameter D2 along its axial length L2.

The shank 18 has both a threaded portion 24 and an unthreaded portion 26. The threaded portion 24 begins within the tapered portion 22 and extends a predetermined length L3 across at least part of the rest of the shank 18 toward the second end 14. The threaded portion 24 is comprised of a single screw thread 28 which wraps around the exterior of the shank 18 in a uniform spiral manner and creates a major diameter D3. The unthreaded portion 26 of the shank 18 has a predetermined length L4. The length of the threaded portion L3 is greater than the length of the unthreaded portion L4.

As also shown in FIG. 1, a single shank slot 30 is located on the first end 12 of the screw 10. The shank slot 30 begins at the tapping point 16 and terminates in a V-shape at a distance L5 along the axial length of the shank 18 and beyond the tapered portion 22. The V-shaped end of the shank slot 30 is formed from a straight edge 32 that is positioned parallel to the longitudinal axis of the screw 10 and an angled edge 34 that forms an angle of a predetermined degree with the straight edge 32. The shank slot 30 interrupts the screw thread 28 and helps the screw 10 auger into a desired material, thereby aiding in the screw's 10 self-tapping ability.

The screw 10 also has two flats 36 located on its first end 12 that extend from the tapping point 16 inwards a distance L6 and into the threaded portion 24, interrupting the screw thread 28. The flats 10 also allow the screw 10 to more easily auger into a desired material.

Referring to FIG. 2, the tapping point 16 on the first end 12 of the screw 10 of FIG. 1 is shown. As shown in FIG. 2, the tapping point 16 is hexagonal and substantially triangular with three major sides 37 and three minor sides 38. Each of the three major sides 37 of the tapping point 16 have an equal length L7 and each of the three minor sides 38 of the tapping point have an equal length L8. The major sides 37 are where the shank slot 30 and flats 36 terminate on the tapping point 16. In other embodiments the tapping point may have a different shape and/or different number of sides, including those embodiments that have a different number of shank slots or flats.

The screw thread 28 shown in FIGS. 1 and 2 has a triple lead 40. However, in other embodiments the screw thread may have a single, double or quadruple lead as desired.

Referring to FIG. 3, the head 20 of an embodiment of the screw 10 of FIGS. 1 and 2 is shown. The head 20 extends outward radially from the shank 18. At its widest point, which is at its outer end, the head 20 has a diameter D4 and the outer end (also known as the “top” of the head 20) is flat except for a six lobed recess 40 having a diameter of D5 and centrally located on the head 20. A tool such as a six lobed screwdriver may be inserted into the recess 40 for rotation of the screw 10. In other embodiments the recess may have a different number of lobes or a different shape as necessary to allow different tools to be used to rotate the screw.

An exemplary embodiment of the screw 10 shown in FIGS. 1 through 3 may have the following dimensions (in inches): an axial length of the tapered portion L1 of 0.25, an axial length of the remainder of the screw L2 of 1.75, an axial length of the unthreaded portion of the shank L4 of 0.265, an axial length of the shank slot L5 of 0.40, length of major sides 37 of the tapping point L7 of 0.220, the minor sides 38 of the tapping point having a predetermined length L8, a minor diameter D2 of a predetermined length, a major diameter D3 of 0.310, a pitch diameter of 0.275, a head diameter D4 of 0.610, and a diameter of the six lob recess D5 of 0.266. However, in other embodiments of the screw the dimensions may differ as desired.

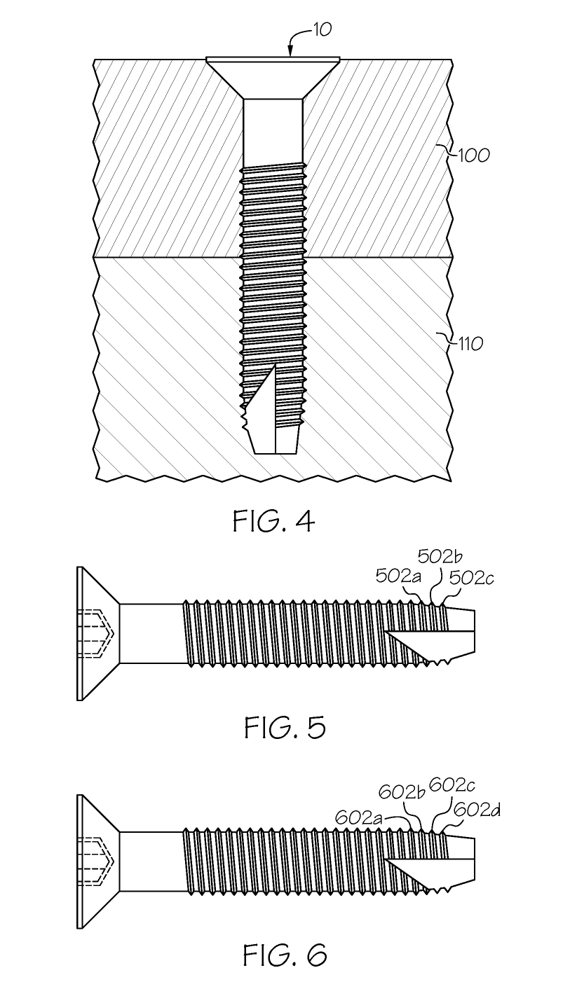

FIG. 4 illustrates the screw 10 of FIGS. 1-3 being used to fasten two materials together; a floorboard 100 and a supporting member 110. One or both of the floorboard 100 and supporting member 110 may be made out of wood, metal, plastic, or other materials as desired. The screw 10 may be installed through use of a hand or power tool that has an attachment corresponding to the six lobed recess 40. As shown in FIG. 4, once fully installed the head 20 may be flush with the top surface of the floorboard 100.

In an exemplary embodiment the screw is made from a material such as steel that undergoes case hardening. In an exemplary embodiment, after case hardening a steel screw may exhibit a Rockwell C hardness (“Rc”) value in the range of Rc36-40 for the core hardness, and Rc50-58 for the surface hardness, with a case hardening depth of 0.006-0.011 inches. In such an exemplary embodiment, the steel used may be AISI 1022 steel or AISI 10B21 steel. However, in other embodiments different types of steel may be case hardened to achieve the desired hardness levels. Such hardening serves to reduce the incidence of “spinning” which is a condition caused by failure of the screw threads as they are driven through the materials to be fastened together. Reduction of the occurrence of spinning is highly desirable as a screw that experiences such a screw thread failure has little or no holding power and must, in many instances, be removed to allow a second screw to be inserted in its place.

As was noted earlier herein, embodiments of the invention may be used to secure a first material to a second material. An example provided was the attachment of a floorboard 100 and supporting member 110. In such an application, as well as many others, a large number of screws 10 may be required to be installed in order to properly secure the first and second material together. As will be understood by one ordinarily skilled in the art, a screw that can be installed more quickly has an installation cost advantage over a screw that requires more time to install. Such an advantage becomes more significant as the number of screws to be installed increases. As is illustrated by the test data representing installation times shown in Table 1, an embodiment of the inventive screw 10 exhibits reduced installation times over that of a previously known screw design. As is shown, an embodiment of the invention may be installed an average of 0.05 seconds faster than known designs. Over the course of installing hundreds or thousands of such screws, a significant amount of time may be saved through the use of the invention.

TABLE 1

| Time To Install An Embodiment | Time To Install Known screws |
|---|---|
| Of The Invention (In Seconds) | Designs (In Seconds) |
| 0.28 | 0.36 |
| 0.25 | 0.36 |
| 0.36 | 0.36 |
| 0.33 | 0.35 |
| 0.31 | 0.39 |
| 0.31 | 0.35 |
| 0.31 | 0.36 |
| 0.30 | 0.36 |
| 0.31 | 0.36 |
| 0.31 | 0.35 |
| 0.33 | 0.36 |
| 0.33 | 0.35 |
| Ave = .31 | Ave = .36 |

In addition to installation time, the holding power of a screw may be a critical characteristic in certain applications. Screws that have greater holding power may produce a more reliable and durable installation, reducing future repair or failure cost. Breakaway torque is a measure of the torque required to cause a fastener to start to rotate after installation. A higher level of breakaway torque represents an increased resistance to a screw loosening as the result of forces applied to the materials being fastened by the screw. Thus, a higher level of breakaway torque represents a greater amount of holding power. As shown in the test results of Table 2, an embodiment of the invention has a higher average breakaway torque than that of a known design. Thus, such an embodiment may result in an improvement in the holding power over known designs. This improved holding power may result in a more reliable and durable installation.

TABLE 2

| Breakaway In Inch Lbs. | |
|---|---|
| Exhibited By An | Breakaway In Inch Lbs. |
| Embodiment Of The | Exhibited By Known |
| Invention | Screw Designs |
| 60 | 65 |
| 90 | 55 |
| 80 | 75 |
| 80 | 83 |
| 85 | 75 |
| 86 | 85 |
| 75 | 60 |
| 87 | 82 |
| 96 | 85 |
| 90 | 80 |
| 90 | 80 |
| 101 | 75 |
| Ave 85 Inch Lbs | Ave 75 Inch Lbs |

Embodiments of the invention may comprise a threaded section with various numbers of thread leads, as one ordinarily skilled in the art will understand, a greater number of thread leads will result in a screw that in many instances installs more quickly than those screws with lesser number. As illustrated in FIGS. 5 and 6, preferred embodiments of the invention may have triple lead threads 502 or four lead threads 602. Other embodiments of the invention may have greater or fewer number of lead threads depending upon the intended application of the screw.

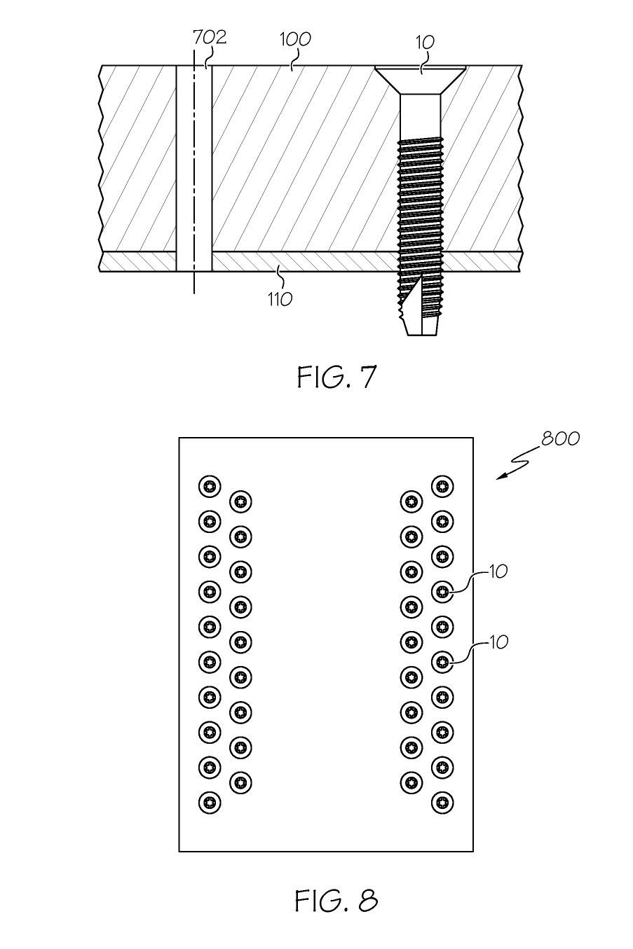

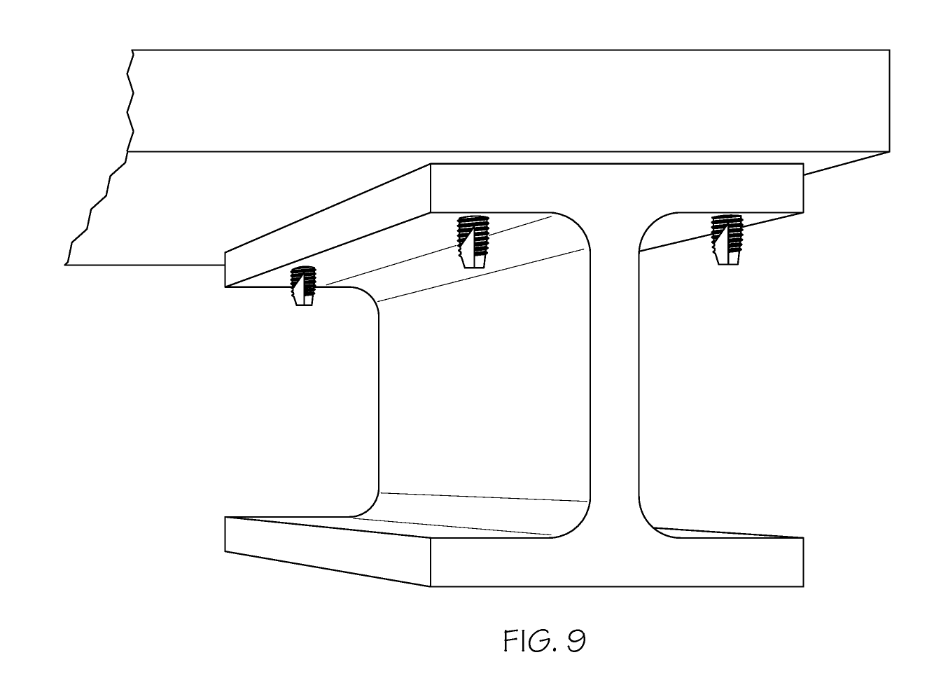

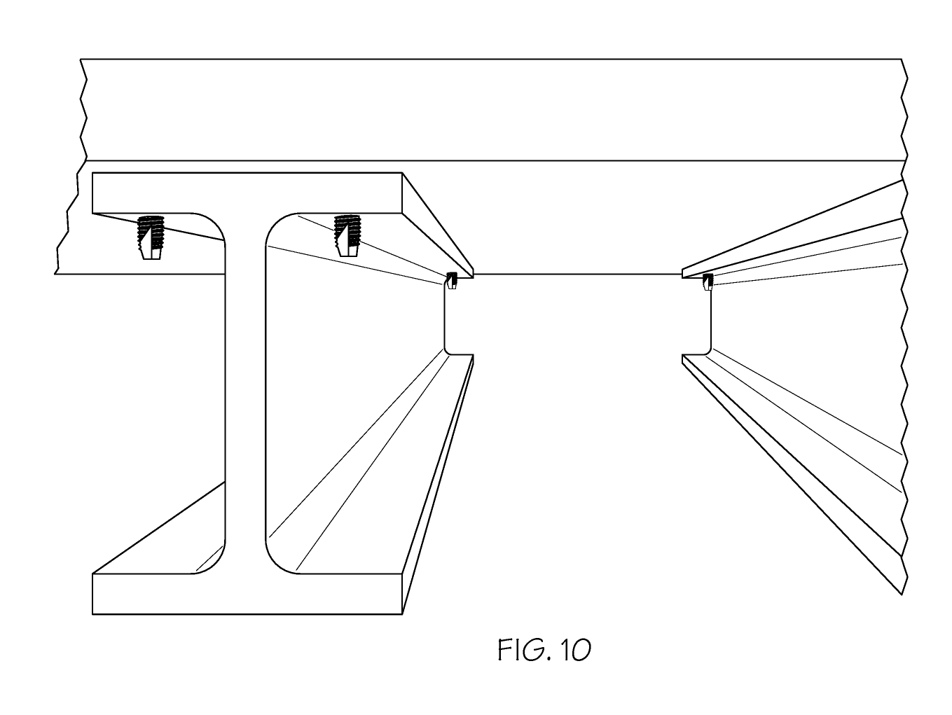

As illustrated in FIG. 7, a floorboard 100 and supporting member 110 may be pre-drilled as shown at 702 and a screw 10 inserted through the floorboard and supporting member. FIG. 8 illustrates a test setup 800 in which a series of screws were installed to test performance against known screw designs. FIGS. 9 and 10 illustrate screw tips protruding from a supporting member in the test setup from FIG. 8.

While the foregoing written description of the invention enables one of ordinary skill to make and use what is considered presently to be the best mode thereof, those of ordinary skill will understand and appreciate the existence of variations, combinations, and equivalents of the specific embodiments and examples herein. The invention should therefore not be limited by the above described embodiments, methods, and examples, but by all embodiments within the scope and spirit of the invention.

What is claimed is:

1. A screw fastener, comprising:
a first end and a second end, with a shank running between said first end and said second end, said shank having threaded and unthreaded portions, said shank having a tapered portion ending at a tapping point at said first end, and said shank having a shank slot extending inward from said tapping point and terminating in said threaded portion;
a head on said second end, said head extending outward radially from said shank; and
a single screw thread wrapped around said shank throughout said threaded portion.

2. The screw fastener of claim 1, wherein said head has a six lobed recess for receiving a tool.

3. The screw fastener of claim 1, wherein the length of said threaded portion is greater than the length of said unthreaded portion.

4. The screw fastener of claim 1, wherein said screw thread has a triple lead.

5. The screw fastener of claim 1, wherein said screw thread has a double lead.

6. The screw fastener of claim 1, wherein said screw thread has a quadruple lead.

7. The screw fastener of claim 1, wherein said tapered portion has one or more flats extending inward from said tapping point.

8. The screw fastener of claim 1, wherein said screw is made from case hardened steel.

9. The screw fastener of claim 8, wherein said screw exhibits a surface hardness value of Rc50-58.

10. The screw fastener of claim 8, wherein said screw exhibits a core hardness value of Rc36-40.

11. The screw fastener of claim 1, wherein said tapping point is polygonal in shape.

12. The screw fastener of claim 11, wherein said tapping point is hexagonal.
